(19) United States
(12) Patent Application Publication
(10) Pub. No.: US 2019/0122082 A1
(43) Pub. Date: Apr. 25, 2019

(54) INTELLIGENT CONTENT DISPLAYS

(71) Applicant: Motionloft, Inc., San Francisco, CA (US)

(72) Inventors: Mark Cuban, Dallas, TX (US); Joyce Reitman, San Francisco, CA (US); Paul McAlpine, Dublin, CA (US)

(21) Appl. No.: 15/790,908

(22) Filed: Oct. 23, 2017

(51) Int. Cl. G06K 9/62; G06K 9/46; G06T 7/73

(52) U.S. Cl. CPC G06K 9/6267; G06K 9/4604; G06F 3/14; G06T 7/73; G06K 9/6202

(57) ABSTRACT

An intelligent content display system includes an electronic display and one or more image sensors having a field of view. The image sensors generate image data representing a scene within the field of view. One or more conditions can be determined from the image data, such as types of objects present in the scene, including people, vehicles, among others. Such detected conditions may be used to determine what content to display on the electronic display in order to optimize the display. A model may be trained using training data to make such as a determination based on the present detected condition. The training data may include historical data which may include various performance measure values and the associated display content associated with certain types of detected objects.

### BACKGROUND

Entities are increasingly adopting electronic displays to increase the versatility of signage. For example, electronic displays may be used to display content for advertising, guidance, and public awareness, among a wide variety of other applications. In particular, electronic displays enable the displayed content to be changed quickly, such as a rotating series of ads, rather than static content of a traditional non-electronic display such as a poster or billboard. However, a persistent challenge is determining what kind of content should be displayed to optimize effectiveness of the display. This challenge is further complicated by the many variables that may be present. For example, the optimal display content may be different depending on time of day, weather conditions, viewer demographics, and various other variables, some of which may be even be difficult to define. Thus, current technology does not enable the full performance potential of the dynamic nature of electronic display technology.

### BRIEF DESCRIPTION OF THE DRAWINGS

Various embodiments in accordance with the present disclosure will be described with reference to the drawings, in which:

FIG. 1 illustrates an electronic display device with integrated image sensor that can be utilized, in accordance with various embodiments of the present disclosure.

FIG. 2 illustrates an electronic display system with an object detection device that can be utilized, in accordance with various embodiments of the present disclosure.

FIG. 3 illustrates an electronic display system with a remote image sensor that can be utilized, in accordance with various embodiments of the present disclosure.

FIG. 4 illustrates components of an example electronic display device that can be utilized, in accordance with various embodiments of the present disclosure.

FIG. 5 illustrates an example implementation of an electronic display system, in accordance with various embodiments of the present disclosure.

FIG. 6 illustrates an example approach to detecting objects within a field of view of a camera of an electronic display system, in accordance with various embodiments of the present disclosure.

FIG. 7 illustrates an example process of determining content to display, in accordance with various embodiments of the present disclosure.

FIG. 8 illustrates an example process for determining content based on multiple detected objects, in accordance with example embodiments.

FIG. 9 illustrates an example process of updating content of a display, in accordance with example embodiments.

FIG. 10 illustrates a process for optimizing display content under various conditions, in accordance with various embodiments of the present disclosure.

FIG. 11 illustrates an example process of training a content selection model, accordance with example embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Systems and methods in accordance with various embodiments of the present disclosure may overcome one or more of the aforementioned and other deficiencies experienced in conventional approaches for using electronic displays. In particular, various embodiments provide systems for optimizing content to be displayed on an electronic display. Various embodiments enable detection of certain conditions of an environment or scene (e.g., viewer demographics, weather conditions, traffic conditions) and selection of display content based at least in part on the detected conditions. Specifically, systems and method provided herein enable the detection of objects appearing in a scene captured by an image sensor such as a camera. The detected objects may be classified as belonging to one or more object types, and display content can be selected based on the one or more objects of the objects appearing in the scene. For example, a the system may detect a group of approximately teenage boys appearing in the scene and select content to display that is likely to appeal to the teenage boys. The system may subsequently detect an adult female enter the scene and update the display to display content that may be more likely to appeal to the adult female. Other scenarios and conditions may be taken into account, such as combinations of object types, number of objects, travel direction of objects, among others.

Additionally, various embodiments enable the systems to learn over time what content most optimally drives a certain performance measure under certain conditions (akin to AB testing), thus enabling the system to optimally select content to be displayed under such conditions. A camera or other type of image sensor can be used to capture image data of a field of view containing the environment or scene, including various conditions. For example, a candidate content item aimed to attract people to enter a store may be displayed for a certain period of time, and image data of a scene is analyzed during the period of time to determine how many people entered a store during that time. A second candidate content item may be displayed and a number of people entering the store can be detected. Thus, it can be determined which of the candidate content items is more effective. Various other functions and advantages are described and suggested below as may be provided in accordance with various embodiments.

The dynamic nature of electronic displays provides the potential for optimal utilization of the content real estate of the display. However, as mentioned, current technology does not enable such a potential to be reached. Embodiments of the present disclosure aim to improve utilization of electronic displays by learning what content should be displayed based on image data captured of a field of view for driving a certain performance measure such as number of visitors to an establishment, number of sales, time spent looking at the display, among others. Conventional image or video analysis approaches may require the captured image or video data to be transferred to a server or other remote system for analysis. As mentioned, this requires significant bandwidth and causes the data to be analyzed offline and after the transmission, which prevents actions from being initiated in response to the analysis in near real time. Further, in many instances it will be undesirable, and potentially unlawful, to collect information about the locations, movements, and actions of specific people. Thus, transmission of the video data for analysis may not be a viable solution. There are various other deficiencies to conventional approaches to such tasks as well.

Accordingly, approaches in accordance with various embodiments provide systems, devices, methods, and software, among other options, that can provide for the near real time detection of a scene and/or specific types of objects, as may include people, vehicles, products, and the like, within the scene, and determine content to be displayed on an electronic display based on the detected objects, and performed in a way that requires minimal storage and bandwidth and does not disclose information about the persons represented in the captured image or video data, unless otherwise instructed or permitted. In one example, the detected objects may include people in viewing proximity of the display (i.e., viewers), and the content displayed may be determined based at least in part of certain detected characteristics of the people. In various embodiments, machine learning techniques are utilized to earn the optimal content to display in order to drive a performance measure based on detected conditions of the scene and/or detected types of objects. Various other approaches and advantages will be appreciated by one of ordinary skill in the art in light of the teachings and suggestions contained herein.

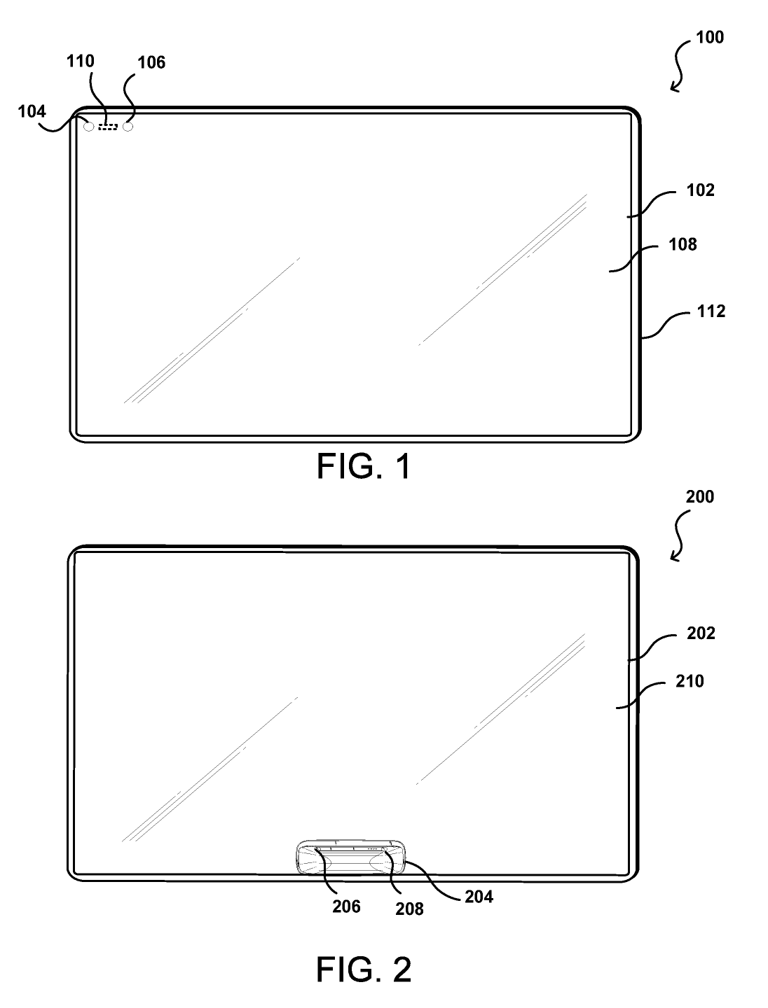

FIGS. 1-3 illustrate various embodiments, among many others, of an intelligent content display system that determines display content based at least in part of conditions or performance measures determined through computer vision and machine learning techniques disclosed herein. The intelligent content display system includes an electronic display for displaying the content and at least one image sensor having a field of view of interest. The intelligent content display system may have many form factors and utilize various techniques that fall within the scope of the present disclosure. For example, FIG. 1 illustrates a content display device 100 with an electronic display 102 and integrated image sensor 104, 106 in accordance with various embodiments. The display device 100 may further include an onboard processor and memory.

The image sensors 104, 106 may each have a field of view and capture image data representing the respective field of view or a scene within the field of view. In various embodiments, the image sensors 104, 106 are a pair of cameras 104, 106 useful in capturing two sets of video data with partially overlapping fields of view which can be used to provide stereoscopic video data. In various embodiments, the cameras 104, 106 are positioned at an angle such that when the content display device 100 is positioned in a conventional orientation, with the front face 108 of the device being substantially vertical, the cameras 104, 106 will capture video data for items positioned in front of, and at the same height or below, the position of the cameras. As known for stereoscopic imaging and as discussed in more detail elsewhere herein, the cameras can be configured such that their separation and configuration are known for disparity determinations. Further, the cameras can be positioned or configured to have their primary optical axes substantially parallel and the cameras rectified to allow for accurate disparity determinations. It should be understood, however, that devices with a single camera or more than two cameras can be used as well within the scope of the various embodiments, and that different configurations or orientations can be used as well. Various other types of image sensors can be used as well in different devices.

The electronic display 102 may be directed in generally the same or overlapping direction as the camera 104, 106 and is configured to display various content as determined by the content display device 100. The electronic display 102 may be any type of display type device capable of displaying content, such as liquid crystal display (LCD), light-emitting diode (LED), organic light-emitting diode (OLED) cathode ray tube (CRT), electronic ink (i.e., electronic paper), 3D swept volume display, holographic display, laser display, projection-based display, among others. In some embodiments, the electronic display 102 may be replaced by a mechanical display, such as a rotating display, trivision display, among others.

In various embodiments, the content display device 100 further includes one or more LEDs or other status lights that can provide basic communication to a technician or other observer of the device to indicate a state of the device. For Example, in situations where it is desirable to have people be aware that they are being detected or tracked, it may be desirable to cause the device to have bright colors, flashing lights, etc. The example device 102 also has a set 110 of display lights, such as differently colored light-emitting diodes (LEDs), which can be off in a normal state to minimize power consumption and/or detectability in at least some embodiments. If required by law, at least one of the LEDs might remain illuminated, or flash illumination, while active to indicate to people that they are being monitored. The LEDs 110 can be used at appropriate times, such as during installation or configuration, trouble shooting, or calibration, for example, as well as to indicate when there is a communication error or other such problem to be indicated to an appropriate person. The number, orientation, placement, and use of these and other indicators can vary between embodiments. In one embodiment, the LEDs can provide an indication during installation of power, communication signal (e.g., LTE) connection/strength, wireless communication signal (e.g., WiFi or Bluetooth) connection/strength, and error state, among other such options.

The memory on the content display device 100 may include various types of storage elements, such as random access memory (e.g., DRAM) for temporary storage and persistent storage (e.g., solid state drive, hard drives). In at least some embodiments, the memory can have sufficient capacity to store a certain number of frames of video content from both cameras 104, 106 for analysis. In various embodiments, the frames are discarded or detected from memory immediately upon analysis thereof In a subset of embodiments, the persistent storage may have sufficient capacity to store a limited amount of video data, such as video for a particular event or occurrence detected by the device. In a further subset of such embodiments, the persistent storage has insufficient capacity to store lengthy periods of video data, which can prevent the hacking or inadvertent access to video data including representations of the people contained within the field of view of those cameras during the period of recording. By limiting the capacity of the storage to only the minimal amount of video data needed to perform video processing, the amount of data that could be comprised is minimal as well, which provides increased privacy in contrast to system that store a larger amount of data.

In various embodiments, a processor on the content display device 100 analyzes the image data captured by the cameras 104, 106 to make various determinations regarding display content. The processor may access the image data (e.g., frames of video content) from memory as the image data is created and process and analyze the image data in real-time or near real-time. Real-time as used herein can refer to a processing sequence in which data is processed as soon as designated computing resource is available and may be subject to various real-time constraints, such as hardware constraints, computing constraints, design constraints, and the like. In some embodiments, the processor may access and process every frame in a sequence of frames of video content. In some other embodiments, the processor may access and process every n number of frames for analysis purpose. In some embodiments, the image data is deleted from memory as soon as it is analyzed, or as soon as the desired information is extracted from the image data. For example, analysis of the image data may include extracting certain features of the image data, such as those forming a feature vector. Thus, the image data is deleted as soon as the features are determined. This way, the actual image data, which may include more information than needed, can be deleted, and the extracted features can be used for further analysis.

In various embodiments, the extraction of features from the image data is performed on the processor which is local to the content display device 100. For example, the processor may be contained in the same device body as the memory and the cameras, which may be communicable with each other via hardwired connections. Thus, the image data is processed within the content display device 100 and is not transmitted to any other device, which reduces the likelihood of the image data being compromised. Additionally, as the image data is processed and subsequently deleted in real-time (or near real-time) as it is generated by the cameras 104, 106, the likelihood of the image data being compromised is further reduced, as the image data may only exist for a very short period of time.

Image data captured by the cameras 104, 106 and content displayed on the display 102 can be related in several ways. In one example, the image data can be analyzed to determine an effectiveness of displayed content, akin to performing AB testing of various content. In this example, the image data may include information regarding a performance measure and can be analyzed to determine a value of the performance measure. For example, the content display device 100 may be placed in a display window of a store. A first content (e.g., advertisement, message) may be displayed on the display for a first period of time. The cameras 104, 106 may capture a field of view near the entrance, such that the image data can be analyzed to determine how many people walked by the store, and the same or additional cameras may capture image data used to determine how many people entered the store. In this scenario, the performance measure may be the ratio between how many people entered the store and how many people walked by the store. Thus, a first value of the performance measure can be determined for the first content. This performance measure may be interpreted as an effectiveness of the content displayed on the content. Accordingly, a second content, different at least in some respect from the first content, may be displayed for a second period of time and the cameras 104, 106 can capture the same field of view and a ratio between the number people who entered the store and the number of people walking by the store can be determined from the image data to determine a second value of the performance measure for the second content. Various other factors may be held constant such that the difference between the first value and the second value of the performance content can be reasonably attributed to the first and second content. Thus, one of the first and second content can be determined to be more effective than the other for getting people to enter the store based on the first and second values of the performance measure. These techniques can be used to determine the best content item to display from a group of content items.

These above techniques may be performed for additional content options and under various other conditions and for various types of performance measures, such that optimal content can be determined for respective constraints. Certain machine learning techniques such as neural networks may be used. A condition refers to an additional factor beyond the content displayed that may have an effect on the performance measure, and which may affect the optimal content. Example types of conditions include object oriented conditions such as a type of object identified in the representation of the scene as captured by the cameras 104, 106, a combination of objects identified in the representation of the scene, a number of objects detected in the representation of the scene, a movement path of one or more objects detected in the scene, environmental conditions such as weather, or one or more characteristics detected in the scene from analyzing image data from the cameras. These and other conditions are examples of conditions that can be detected using the camera 104, 106. There may be additional conditions that are not image based, such as time of day, time of year, current events, and so forth. Thus, certain such conditions may be associated with the period of time for which a value of a performance measure is obtained such that the optimal display content can be determined given such conditions. A performance measure may refer to any qualitative or quantitative measure of performance, including positive measures where a high value is desirable or negative measures where a low value is desirable. Additional examples of performance measures may include number of sales made, number of interactions with the display where the display is an interactive display, number of website visits, number of people who look at the display, which can be determined using image data from the camera 104, 106, among many others.

As mentioned, in addition to determining the effectiveness of display content and determining the best content to display from a group of content items, the content display device can further determine optimal content to display given certain current conditions. For example, the cameras 104, 106 may capture image data. The image data may be analyzed by the local processor in real-time to detect a representation of a scene. One or more conditions may be determined based on the representation of the scene, such as one or more types of objects present in the scene, weather conditions, etc. In some embodiments, one or more feature values may be determined from the representation of the scene to determine a representation of one or more objects, such as humans, animals, vehicles, etc. The representations of the objects may be classified using an object identification model to determine the type of object present. For example, the object identification model may contain one or more sub-models associating features vectors with a plurality of respective object types. Thus, by analyzing the feature vector of a representation of an object, the object identification model may identify the object as belong to one or more types. The object identification model may be a machine learning based model such as one including one or more neural networks that have been trained on training data for identifying and/or classifying image data into one or more object types. In some embodiments, the model may include a neural network for each object type. Additionally, an optimization model may be stored in memory, which has been trained to determine the best content to display based on one or more given conditions. For example, the optimization model may determine the content to display based on the type of object identified in the image data. For example, an object detected in the image data may be identified as a woman with a stroller, and the content may be determined accordingly, such as an advertisement for baby clothes. In various embodiments, the number of objects detected or group comprising objects of one or more different types may also be taken into consideration by the model in determining the content.

In various embodiments, the abovementioned optimization model may be a machine learning based model such as one including one or more neural network that have been trained using training data. The training data may include a plurality of sets of training data, in which each set of training data represents one data point. For example, one set of training data may include a value of the performance measure, a condition (e.g., detected object type, weather, time of day), and a displayed content item. In other words, the set of training data represents the value of the performance measure associated with the combination of the displayed content item and the condition, or the effectiveness of the displayed content item under the content. Thus, given a large number of sets of training data, the model, through classification or regression, can determine the optimal content to display given queried (i.e., currently detected) conditions in order to optimize for one or more performance measures.

In various embodiments, the content display device 100 may further include a housing 112 or device body, in which the display 102 makes up a front face 108 of the device housing 112 and the processor and the memory located within the device housing 112. The camera 104, 106 may be positioned proximate the front face 108 and have a field of view, wherein the display 102 faces the field of view. In some embodiments, the cameras are located at least partially within the housing 112 and a light-capturing component of the cameras 104, 106 are exposed to the field of view so as to capture image data representing a scene in the field of view.

FIG. 2 illustrates a content display system 200 with an electronic display 202 and an object detection device 204, in accordance with various embodiments. In various embodiments, the object detection device 204 includes one or more image sensors 206, 208, such as cameras which function similarly to cameras 104, 106 described above with respect to FIG. 1. The object detection device 204 may also include a processor and memory functioning similarly to those described above with respect to FIG. 1. Thus, the object detection device 204 may capture image data, analyze the image data, and determine content to be displayed on the display 202, utilizing similar techniques as described above with respect to FIG. 1. The object detection device 204 may determine display data, such as instructions for the electronic display, and transmit the data to the display 202, which receives the data (e.g., instructions) from the object detection device and display the appropriate content as dictated by the data. In various embodiments, the electronic display 202 may be a general display that has been retrofitted with the object detection device, turning the general display into an intelligent content display, functioning similarly to the content display device of FIG. 1. In some embodiments, the image processing and analysis may be performed by the object detection device 204 in real-time or near real-time, and the image data may be deleted as soon as it is processed such that it is not transmitted out of the image detection device 204 and only temporarily stored for a brief moment of time. In some embodiments, a portion of the analysis of information extracted from the image data or content determination may be performed by the electronic display 202.

The object detection device 204 may be at least partially embedded in the electronic display 202, for example such that a front face 210 of the object detection device 204 is flush with a front face 210 of the display 202. In some other embodiments, the object detection device 204 may be external but local to the electronic display 202 and mounted to the display 202, such as on top, on bottom, on a side, in front of, and so forth. The object detection device 204 may be communicatively coupled to the electronic display 202 via wired or wireless communications.

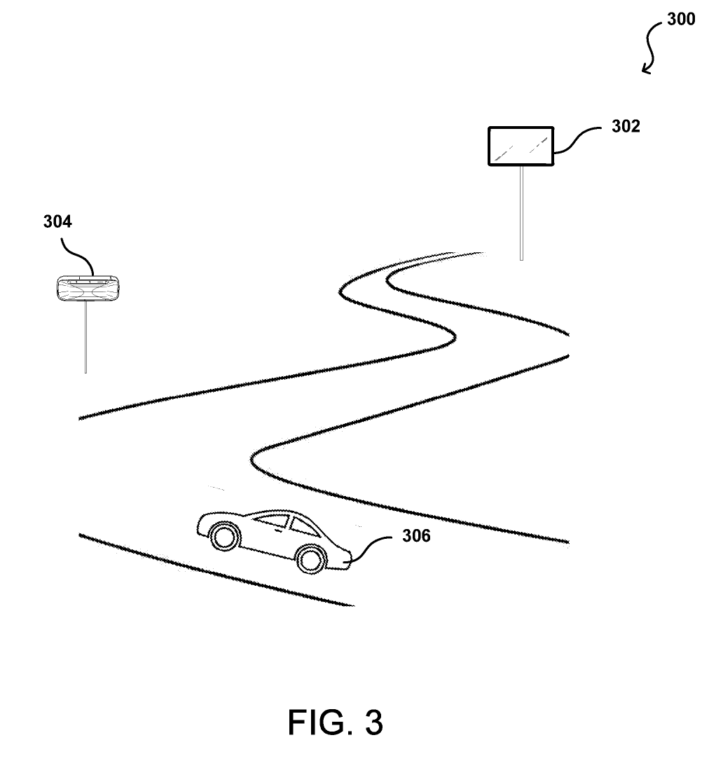

FIG. 3 illustrates an electronic display system 300 with a display 302 and a remote image sensor 304, in accordance with various embodiments of the present disclosure. In such embodiments, the display 302 may be located at a first location and the image sensor 304 may be located at a second location, yet the system 300 carrying out functions similar to be those described above with respect to FIGS. 1 and 2. In the illustrated example, the image sensor 304 is located near one part of a road and the display is located at a position further down the road. Thus, the image sensor 304 may capture a view of a vehicle 306 driving in the direction of the display 302 such that the display can display appropriate content based on the type of vehicle detected using the image sensor 304, and the can be seen from the vehicle or a portion of a period of time. For example, the brand of the vehicle may be detected, and content can be determined that would likely be effective when shown to a driver of that brand of vehicle. In another example, the license plate of the vehicle may be detected, which may be associated with certain information that can be used to determine content to display on the display 302. In an example application, the image sensor 304 may detect vehicles driving past certain checkpoints, and the display 302 may serve as a form of traffic signaling device by displaying information or signals based on the detected vehicles. For example, the display may serve as a metering light, which regulates the flow of traffic entering a freeway according to current traffic conditions on the freeway detected via the image sensor 304. The content display system of the present disclosure may have many different form factors including many that are not explicitly illustrated herein for sake of brevity, none of which are limiting. Any system comprising a display component and an image sensing or detection component configured to carry out the techniques described herein are within the scope of the present disclosure.

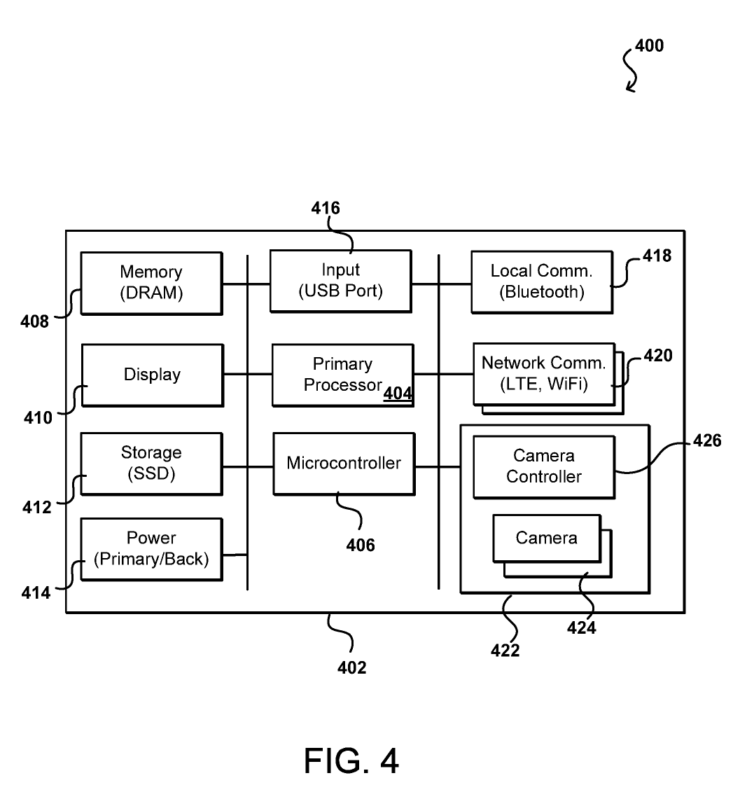

FIG. 4 illustrates components of an example content display system 400 that can be utilized, in accordance with various embodiments of the present disclosure. In this example, at least some of the components would be installed on one or more printed circuit boards (PCBs) 402 contained within a housing of the system. Elements such as the display elements 410 and cameras 424 can also be at least partially exposed through and/or mounted in the device housing. In this example, a primary processor 404 (e.g., at least one CPU) can be configured to execute instructions to perform various functionality discussed herein. The device can include both random access memory 408, such as DRAM, for temporary storage and persistent storage 412, such as may include at least one solid state drive SSD, although hard drives and other storage may be used as well within the scope of the various embodiments. In at least some embodiments, the memory 408 can have sufficient capacity to store frames of video content from both cameras 424 for analysis, after which time the data is discarded. The persistent storage 412 may have sufficient capacity to store a limited amount of video data, such as video for a particular event or occurrence detected by the device, but insufficient capacity to store lengthy periods of video data, which can prevent the hacking or inadvertent access to video data including representations of the people contained within the field of view of those cameras during the period of recording.

The display can include at least one display 410, such as display 102 of FIG. 1. As described above, the display is configured to display various content as determined by the content display system 400. The display 410 may be any type of display type device capable of displaying content, such as liquid crystal display (LCD), light-emitting diode (LED), organic light-emitting diode (OLED) cathode ray tube (CRT), electronic ink (i.e., electronic paper), 3D swept volume display, holographic display, laser display, projection-based display, among others. In various examples this includes one or more LEDs or other status lights that can provide basic communication to a technician or other observer of the device. It should be understood, however, that screens such as LCD screens or other types of displays can be used as well within the scope of the various embodiments. In at least some embodiments one or more speakers or other sound producing elements can also be included, which can enable alarms or other type of information to be conveyed by the device. Similarly, one or more audio capture elements such as a microphone can be included as well. This can allow for the capture of audio data in addition to video data, either to assist with analysis or to capture audio data for specific periods of time, among other such options. As mentioned, if a security alarm is triggered the device might capture video data (and potentially audio data if a microphone is included) for subsequent analysis and/or to provide updates on the location or state of the emergency, etc. In some embodiments a microphone may not be included for privacy or power concerns, among other such reasons.

The content display system 400 can include various other components, including those shown and not shown, that might be included in a computing device as would be appreciated to one of ordinary skill in the art. This can include, for example, at least one power component 414 for powering the device. This can include, for example, a primary power component and a backup power component in at least one embodiment. For example, a primary power component might include power electronics and a port to receive a power cord for an external power source, or a battery to provide internal power, among solar and wireless charging components and other such options. The device might also include at least one backup power source, such as a backup battery, that can provide at least limited power for at least a minimum period of time. The backup power may not be sufficient to operate the device for length periods of time, but may allow for continued operation in the event of power glitches or short power outages. The device might be configured to operate in a reduced power state, or operational state, while utilizing backup power, such as to only capture data without immediate analysis, or to capture and analyze data using only a single camera, among other such options. Another option is to turn off (or reduce) communications until full power is restored, then transmit the stored data in a batch to the target destination. As mentioned, in some embodiments the device may also have a port or connector for docking with the mounting bracket to receive power via the bracket.

The system can have one or more network communications components 420, or sub-systems, that enable the device to communicate with a remote server or computing system. This can include, for example, a cellular modem for cellular communications (e.g., LTE, 5G, etc.) or a wireless modem for wireless network communications (e.g., WiFi for Internet-based communications). The system can also include one or more components 418 for “local” communications (e.g., Bluetooth) whereby the device can communicate with other devices within a given communication range of the device. Examples of such subsystems and components are well known in the art and will not be discussed in detail herein. The network communications components 420 can be used to transfer data to a remote system or service, where that data can include information such as count, object location, and tracking data, among other such options, as discussed herein. The network communications component can also be used to receive instructions or requests from the remote system or service, such as to capture specific video data, perform a specific type of analysis, or enter a low power mode of operation, etc. A local communications component 418 can enable the device to communicate with other nearby detection devices or a computing device of a repair technician, for example. In some embodiments, the device may additionally (or alternatively) include at least one input 416 and/or output, such as a port to receive a USB, micro-USB, FireWire, HDMI, or other such hardwired connection. The inputs can also include devices such as keyboards, push buttons, touch screens, switches, and the like.

The illustrated detection device also includes a camera subsystem 422 that includes a pair of matched cameras 424 for stereoscopic video capture and a camera controller 426 for controlling the cameras. Various other subsystems or separate components can be used as well for video capture as discussed herein and known or used for video capture. The cameras can include any appropriate camera, as may include a complementary metal-oxide-semiconductor (CMOS), charge coupled device (CCD), or other such sensor or detector capable of capturing light energy over a determined spectrum, as may include portions of the visible, infrared, and/or ultraviolet spectrum. Each camera may be part of an assembly that includes appropriate optics, lenses, focusing elements, shutters, and other such elements for image capture by a single camera, set of cameras, stereoscopic camera assembly including two matched cameras, or other such configuration. Each camera can also be configured to perform tasks such as autofocusing, zoom (optical or digital), brightness and color adjustments, and the like. The cameras 424 can be matched digital cameras of an appropriate resolution, such as may be able to capture HD or 4K video, with other appropriate properties, such as may be appropriate for object recognition. Thus, high color range may not be required for certain applications, with grayscale or limited colors being sufficient for some basic object recognition approaches. Further, different frame rates may be appropriate for different applications. For example, thirty frames per second may be more than sufficient for tracking person movement in a library, but sixty frames per second may be needed to get accurate information for a highway or other high speed location. As mentioned, the cameras can be matched and calibrated to obtain stereoscopic video data, or at least matched video data that can be used to determine disparity information for depth, scale, and distance determinations. The camera controller 426 can help to synchronize the capture to minimize the impact of motion on the disparity data, as different capture times would cause some of the objects to be represented at different locations, leading to inaccurate disparity calculations.

The example content display system 400 also includes a microcontroller 406 to perform specific tasks with respect to the device. In some embodiments, the microcontroller can function as a temperature monitor or regulator that can communicate with various temperature sensors (not shown) on the board to determine fluctuations in temperature and send instructions to the processor 404 or other components to adjust operation in response to significant temperature fluctuation, such as to reduce operational state if the temperature exceeds a specific temperature threshold or resume normal operation once the temperature falls below the same (or a different) temperature threshold. Similarly, the microcontroller can be responsible for tasks such as power regulation, data sequencing, and the like. The microcontroller can be programmed to perform any of these and other tasks that relate to operation of the detection device, separate from the capture and analysis of video data and other tasks performed by the primary processor 404.

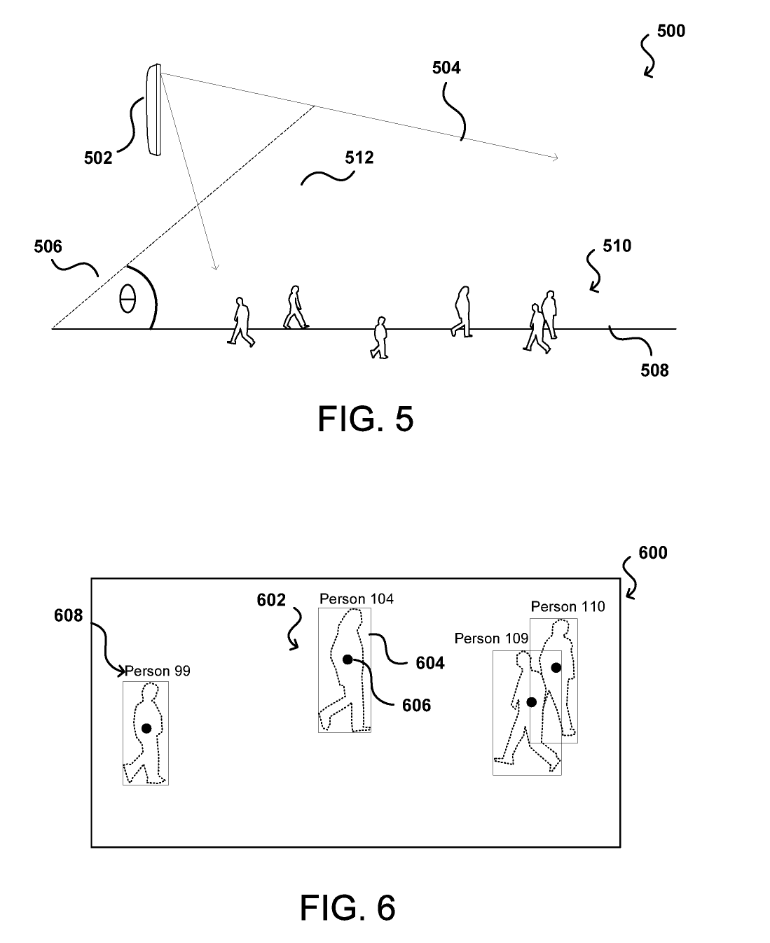

FIG. 5 illustrates an example implementation 500 of an electronic display device, in accordance with various embodiments of the present disclosure. FIG. 5 illustrates an example arrangement 500 in which an electronic display device 502 can capture and analyze video information in accordance with various embodiments and display selected content accordingly. In this example, the display device 502 is positioned with the front face substantially vertical, and the detection device at an elevated location, such that the field of view 504 of the cameras of the device and the display is directed towards a region of interest 508, where that region is substantially horizontal (although angled or non-planar regions can be analyzed as well in various embodiments). As mentioned, the cameras can be angled such that a primary axis 512 of each camera is pointed towards a central portion of the region of interest. In this example, the cameras can capture video data of the people 510 walking in the area of interest. As mentioned, the disparity information obtained from analyzing the corresponding video frames from each camera can help to determine the distance to each person, as well as information such as the approximate height of each person. If the detection device is properly calibrated the distance and dimension data should be relatively accurate based on the disparity data. The video data can be analyzed using any appropriate object recognition process, computer vision algorithm, artificial neural network (ANN), or other such mechanism for analyzing image data (i.e., for a frame of video data) to detect objects in the image data. The detection can include, for example, determining feature points or vectors in the image data that can then be compared against patterns or criteria for specific types of objects, in order to identify or recognize objects of specific types. Such an approach can enable objects such as benches or tables to be distinguished from people or animals, such that only information for the types of object of interest can be processed.

In this example, the cameras capture video data which can then be processed by at least one processor on the detection device. The object recognition process can detect objects in the video data and then determine which of the objects correspond to objects of interest, in this example corresponding to people. The process can then determine a location of each person, such as by determining a boundary, centroid location, or other such location identifier. The process can then provide this data as output, where the output can include information such as an object identifier, which can be assigned to each unique object in the video data, a timestamp for the video frame(s), and coordinate data indicating a location of the object at that timestamp. In one embodiment, a location (x, y, z) timestamp (t) can be generated as well as a set of descriptors (d1, d2, . . . ) specific to the object or person being detected and/or tracked. Object matching across different frames within a field of view, or across multiple fields of view, can then be performed using a multidimensional vector (e.g., x, y, z, t, d1, d2, d3, . . . ). The coordinate data can be relative to a coordinate of the detection device or relative to a coordinate set or frame of reference previously determined for the detection device. Such an approach enables the number and location of people in the region of interest to be counted and tracked over time without transmitting, from the detection device, any personal information that could be used to identify the individual people represented in the video data. Such an approach maintains privacy and prevents violation of various privacy or data collection laws, while also significantly reducing the amount of data that needs to be transmitted from the detection device.

As illustrated, however, the video data and distance information will be with respect to the cameras, and a plane of reference 506 of the cameras, which can be substantially parallel to the primary plane(s) of the camera sensors. For purposes of the coordinate data provided to a customer, however, the customer will often be more interested in coordinate data relative to a plane 508 of the region of interest, such as may correspond to the floor of a store or surface of a road or sidewalk that can be directly correlated to the physical location. Thus, in at least some embodiments a conversion or translation of coordinate data is performed such that the coordinates or position data reported to the customer corresponds to the plane 508 (or non-planar surface) of the physical region of interest. This translation can be performed on the detection device itself, or the translation can be performed by a data aggregation server or other such system or service discussed herein that receives the data, and can use information known about the detection device 502, such as position, orientation, and characteristics, to perform the translation when analyzing the data and/or aggregating/correlating the data with data from other nearby and associated detection devices. Mathematical approaches for translating coordinates between two known planes of reference are well known in the art and, as such, will not be discussed in detail herein.

FIG. 6 illustrates an example approach to detecting objects within a field of view of a camera of an electronic display system, in accordance with various embodiments of the present disclosure. In this example, the dotted lines represent people 602 who are contained within the field of view of the cameras of a detection device, and thus represented in the captured video data. After recognition and analysis, the people can be represented in the output data by bounding box 604 coordinates or centroid coordinates 606, among other such options. As mentioned, each person (or other type of object of interest) can also be assigned a unique identifier 608 that can be used to distinguish that object, as well as to track the position or movement of that specific object over time. Where information about objects is stored on the detection device for at least a minimum period of time, such an identifier can also be used to identify a person that has walked out of, and back into, the field of view of the camera. Thus, instead of the person being counted twice, this can result in the same identifier being applied and the count not being updated for the second encounter. There may be a maximum amount of time that the identifying data is stored on the device, or used for recognition, such that if the user comes back for a second visit at a later time this can be counted as a separate visit for purposes of person count in at least some embodiments. In some embodiments the recognition information cached on the detection device for a period of time can include a feature vector made up of feature points for the person, such that the person can be identified if appearing again in data captured by that camera while the feature vector is still stored. It should be understood that while primary uses of various detection devices do not transmit feature vectors or other identifying information, such information could be transmitted if desired and permitted in at least certain embodiments.

The locations of the specific objects can be tracked over time, such as by monitoring changes in the coordinate information determined for a sequence of video frames over time. The type of object, position for each object, and quantity of objects can be reported by the detection device and/or data service, such that a customer can determine where objects of different types are located in the region of interest. In addition to the number of objects of each type, the location and movement of those types of objects can also be determined. If, for example, the types of objects represent people, automobiles, and bicycles, then such information can be used to determine how those objects move around an intersection, and can also be used to detect when a bicycle or person in in the street disrupting traffic, a car is driving on a sidewalk, or another occurrence is detected such that an action can be taken. As mentioned, an advantage of approaches discussed herein is that the position (and other) information can be provided in near real time, such that the determination of the occurrence can be determined while the occurrence is ongoing, such that an action can be taken. This can include, for example, generating audio instructions, activating a traffic signal, dispatching a security officer, or another such action. The real time analysis can be particularly useful for security purposes, where action can be taken as soon as a particular occurrence is detected, such as a person detected in an unauthorized area, etc. Such real time aspects can be beneficial for other purposes as well, such as being able to move employees to customer service counters or cash registers as needed based on current customer locations, line lengths, and the like. For traffic monitoring, this can help determine when to activate or deactivate metering lights, change traffic signals, and perform other such actions.

In other embodiments the occurrence may be logged for subsequent analysis, such as to determine where such occurrences are taking place in order to make changes to reduce the frequency of such occurrences. If in a store situation, such movement data can alternatively be used to determine how men and women move through a store, such that the store can optimize the location of various products or attempt to place items to direct the persons to different regions in the store. The data can also help to alert when a person is in a restricted area or otherwise doing something that should generate an alarm, alert, notification, or other such action.

In various embodiments, some amount of image pre-processing can be performed for purposes of improving the quality of the image, as may include filtering out noise, adjusting brightness or contrast, etc. In cases where the camera might be moving or capable of vibrating or swaying on a pole, for example, some amount of position or motion compensation may be performed as well. Background subtraction approaches that can be utilized with various embodiments include mean filtering, frame differencing, Gaussian average processing, background mixture modeling, mixture of Gaussians (MoG) subtraction, and the like. Libraries such as the OPEN CV library can also be utilized to take advantage of the conventional background and foreground segmentation algorithm.

Once the foreground portions or “blobs” of image data are determined, those portions can be processed using a computer vision algorithm for object recognition or other such process. Object recognition typically makes use of one or more classifiers that have been trained to recognize specific types of categories of objects, such as people, cars, bicycles, and the like. Algorithms used for such purposes can include convolutional or other deep neural networks (DNNs), as may utilize one or more feature extraction libraries for identifying types of feature points of various objects. In some embodiments, a histogram or oriented gradients (HOG)-based approach uses feature descriptors for object detection, such as by counting occurrences of gradient orientation in localized portions of the image data. Other approaches that can be used take advantage of features such as edge orientation histograms and shape contexts, as well as scale- and rotation-invariant feature transform descriptors, although these approaches may not provide the same level of accuracy for at least some data sets.

In some embodiments, an attempt to classify objects that does not require precision can rely on the general shapes of the blobs or foreground regions. For example, there may be two blobs detected that correspond to different types of objects. The first blob can have an outline or other aspect determined that a classifier might indicate corresponds to a human with 85% certainty. Certain classifiers might provide multiple confidence or certainty values, such that the scores provided might indicate an 85% likelihood that the blob corresponds to a human and a 5% likelihood that the blob corresponds to an automobile, based upon the correspondence of the shape to the range of possible shapes for each type of object, which in some embodiments can include different poses or angles, among other such options. Similarly, a second blob might have a shape that a trained classifier could indicate has a high likelihood of corresponding to a vehicle. For situations where the objects are visible over time, such that additional views and/or image data can be obtained, the image data for various portions of each blob can be aggregated, averaged, or otherwise processed in order to attempt to improve precision and confidence. As mentioned elsewhere herein, the ability to obtain views from two or more different cameras can help to improve the confidence of the object recognition processes.

Where more precise identifications are desired, the computer vision process used can attempt to locate specific feature points as discussed above. As mentioned, different classifiers can be used that are trained on different data sets and/or utilize different libraries, where specific classifiers can be utilized to attempt to identify or recognize specific types of objects. For example, a human classifier might be used with a feature extraction algorithm to identify specific feature points of a foreground object, and then analyze the spatial relations of those feature points to determine with at least a minimum level of confidence that the foreground object corresponds to a human. The feature points located can correspond to any features that are identified during training to be representative of a human, such as facial features and other features representative of a human in various poses. Similar classifiers can be used to determine the feature points of other foreground object in order to identify those objects as vehicles, bicycles, or other objects of interest. If an object is not identified with at least a minimum level of confidence, that object can be removed from consideration, or another device can attempt to obtain additional data in order to attempt to determine the type of object with higher confidence. In some embodiments the image data can be saved for subsequent analysis by a computer system or service with sufficient processing, memory, and other resource capacity to perform a more robust analysis.

After processing using a computer vision algorithm with the appropriate classifiers, libraries, or descriptors, for example, a result can be obtained that is an identification of each potential object of interest with associated confidence value(s). One or more confidence thresholds or criteria can be used to determine which objects to select as the indicated type. The setting of the threshold value can be a balance between the desire for precision of identification and the ability to include objects that appear to be, but may not be, objects of a given type. For example, there might be 1,000 people in a scene. Setting a confidence threshold too high, such as at 99%, might result in a count of around 100 people, but there will be a very high confidence that each object identified as a person is actually a person. Setting a threshold too low, such as at 50%, might result in too many false positives being counted, which might result in a count of 1,500 people, one-third of which do not actually correspond to people. For applications where approximate counts are desired, the data can be analyzed to determine the appropriate threshold where, on average, the number of false positives is balanced by the number of persons missed, such that the overall count is approximately correct on average. For many applications this can be a threshold between about 60% and about 85%, although as discussed the ranges can vary by application or situation.

As mentioned, many of the examples herein utilize image data captured by one or more detection devices with a view of an area of interest. In addition to one or more digital still image or video cameras, these devices can include infrared detectors, stereoscopic cameras, thermal sensors, motion sensors, proximity sensors, and other such sensors or components. The image data captured can include one or more images, or video, indicating pixel values for pixel locations of the camera sensor, for example, where the pixel values can represent data such as the intensity or color of ambient, infrared IR, or ultraviolet (UV) radiation detected by the sensor. A device may also include non-visual based sensors, such as radio or audio receivers, for detecting energy emanating from various objects of interest. These energy sources can include, for example, cell phone signals, voices, vehicle noises, and the like. This can include looking for distinct signals or a total number of signals, as well as the bandwidth, congestion, or throughput of signals, among other such options. Audio and other signature data can help to determine aspects such as type of vehicle, regions of activity, and the like, as well as providing another input for counting or tracking purposes. The overall audio level and direction of the audio can also provide an additional input for potential locations of interest. In various embodiments, the devices may also include position or motion sensing devices such as global position system (GPS) devices, gyroscopes, accelerometers, among others.

In some embodiments, a detection device can include an active, structured-light sensor. Such an approach can utilize a set of light sources, such as a laser array, that projects a pattern of light of a certain wavelength, such as in the infrared (IR) spectrum that may not be detectable by the human eye. One or more structured light sensors can be used, in place of or in addition to the ambient light camera sensors, to detect the reflected IR light. In some embodiments sensors can be used that detect light over the visible and infrared spectrums. The size and placement of the reflected pattern components can enable the creation of a three-dimensional mapping of the objects within the field of view. Such an approach may require more power, due to the projection of the IR pattern, but may provide more accurate results in certain situations, such as low light situations or locations where image data is not permitted to be captured, etc. The information obtained through the above-described computer vision and analysis techniques can be used to determine the conditions present, and thus make decisions regarding the content to display based on the detected conditions.

As mentioned, the above techniques can be applied in various ways to determine content to display. In an example scenario, the content determined for display may be customized depending on a number of people detected in a group. For example, the content display device may detect a group of 5 people walking together consistently and make a determination that the group of 5 people make up a single party. The display device may then display content that includes information about a nearby restaurant currently having an open table for 5 people as well as other helpful information such as directions or pictures of example food items.

In another example scenario, the content determined for display may be customized depending on the estimated age or height of people detected in a scene. For example, at a theme park, the content display device may detect a child of a certain height and display rides in the theme park that the child is likely to be tall enough to ride, and other optional information such as directions or a map showing the locations of the rides.

In another example scenario, the content determined for display may be determined based on a detect flow of people. For example, it may be detected that an increasing amount of people are entering a store, and the display may display content indicating that a certain number of additional checkout lanes should be opened in anticipation of the influx in customers. In this scenario, the display and the image sensor may be located remotely. For example, the image sensor may be located near a customer entrance of the store, and the display may be located at an employee room or management office of the store. In another example, a number of people inside a particular store in a shopping plaza may be detected, and the display may display content letting others know that the store is currently crowded.

In another example scenario, the content determined for display may be determined based on a combination of types of objects detected in a scene. For example, a person and an umbrella may be detected in the scene, which may indicate that it is a rainy day. Thus, the content display device may select content that is designated for a rainy day, such as an advertisement for a nearby hot chocolate shop.

In various embodiments, as content displayed by the content display device may change dynamically and based on detected conditions, such as types of objects, the content may necessarily be displayed on a set schedule for based on a certain share of display time. For example, the display may include content from a plurality of different content providers (e.g., companies). For example, a content provider can dictate that their content be displayed to a certain demographic (i.e., object type). The content providers may be charged each time their content is displayed, or for a total time during in which their content was displayed, and/or depending how well the audience matches their preferred demographic. For example the content provide may be charged a certain amount for their content being shown to teenagers and a different amount for their content being shown to adults. In some embodiments, based on historical demographic data, the content display device may determine an estimated amount of “inventory” for various demographic types, and plan the display content accordingly to optimize match between content and audience. In some embodiments, the content providers may provide a maximum amount of time to display their content. In some embodiments, the display value of the display may vary depending on various factors, such as time of day, or number of people walking by the display, or various combinations of factors. In one embodiment, the value of the display may be determined based at least in part on the number of people detected to walk past the display. Thus, the present systems and methods enable values to be determined for time slots of a display.

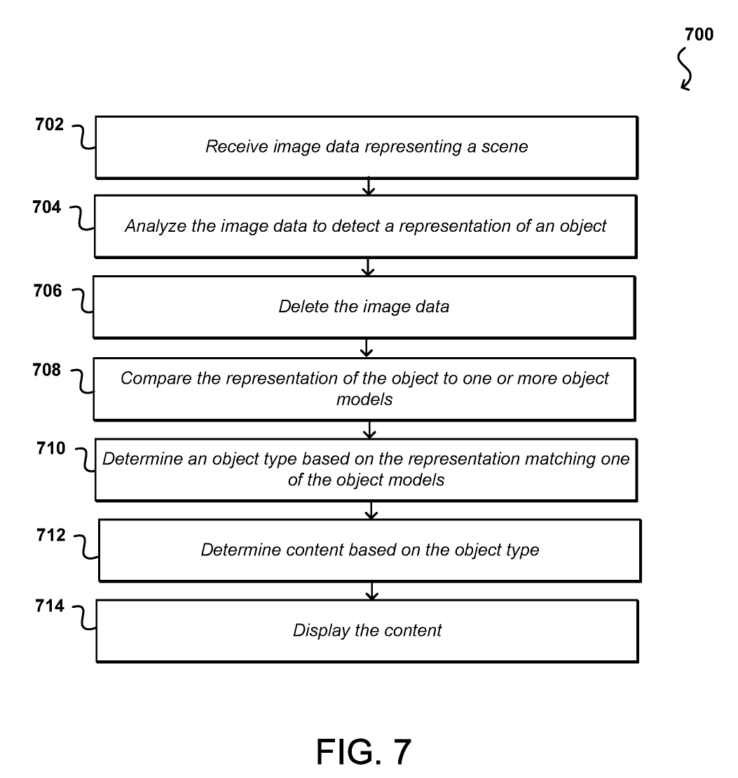

FIG. 7 illustrates an example process 700 of determining content to display, in accordance with various embodiments of the present disclosure. It should be understood for this and other processes discussed herein that there can be additional, alternative, or fewer steps performed in similar or alternative orders, or in parallel, within the scope of the various embodiments unless otherwise stated. In this example, image data representing a scene is received 702. The scene may be captured by an image sensor of a content display device or an image sensor of an object detection device of a content display system. The image data is then analyzed 704 to detect a representation of an object. The representation of the object may include a plurality of feature points that indicate an object in the scene. The representation may include a plurality of pixels used to identify the feature points or otherwise processed to identify the object. After the image data has been analyzed to detect the representation of the object, the image data may be deleted 706, so as to store minimal image data and for a minimal amount of time, thus reducing computing resources while increasing privacy. In an example embodiment, the image data may include a sequence of frames, in which a first set of frames of the sequence of frames may be analyzed and deleted, and subsequently a second set of frames of the sequence of frames may be analyze and deleted. The second set of frames and the first set of frame being adjacent in the sequence or separated by one or more other frames.

The representation of the object may be compared 708 to one or more object models to determine an object type. Specifically, in various embodiments, the object type is determined 710 based on the representation of the object matching one of the object models. In various embodiments, the one or more object models may each be associated with a particular object type (e.g., adult male, baby, car, truck, stroller, shopping bag, hat). For example, an object model for a stroller may include example sets of feature points that are known to represent a stroller, and if the feature points of the detected object match (i.e., similar to, within a certain confidence level) the example feature points, then a determination can be made that the detected feature points indicate a stroller in the scene, and the object type is determined to be “stroller”. In various embodiments, the image data and/or the extracted representation of the one or more object can be analyzed using any appropriate object recognition process, computer vision algorithm, artificial neural network, or other such mechanism for analyzing image data to detect and identify objects in the image data. The detection can include, for example, determining feature points or vectors in the image data that can then be compared against patterns or criteria for specific types of objects, in order to identify or recognize objects of specific types. For example, a neural network can be trained for a certain object type such that the neural network can identify objects occurring in an image as belonging to that object type. A neural network could also classify objects occurring in an image into one or more of a plurality of classes, each of the classes corresponding to a certain object type. In various embodiments, a neural network can be trained by providing training data which includes image data having representations of objects which are annotated as belonging to certain object types. Given a critical amount of training data, the neural network can learn how to classify representations of new objects.

In various embodiments, if the object is a person, the type of object may also include certain emotional states of the person, such as happy, sad, worried, angry, etc. In some embodiments, the emotional state may be determined using real-time inference, in which feature points in a detected facial region of the person are analyzed through various techniques, such as neural networks, to determine an emotional state of the person represented in the image data. The neural networks may be training using training data which includes images of faces annotated with the correct emotional state. In some embodiments, body position may also be used in the analysis.

Thus, content is then determined 712 based on the object type. For example, the content may be an advertisement for baby food is the object type is “stroller”. Accordingly, the content is displayed 714 on the display. In an example embodiment, the position of the one or more objects may also be determined from the image data and the content may be determined based at least in part on the position of the one or more objects. For example, one or more object being relatively close to one another in position may be determined to make up a group or party and thus treated as such in determining the content to display.

The image data in this example can correspond to a single digital image or a frame of digital video, among other such options. The captured image data can be analyzed, on the detection device, to extract image features (e.g., feature vector) or other points or aspects that may be representative of objects in the image data. These can include any appropriate image features discussed or suggested herein. Once the features are extracted, the image data can be deleted. Object recognition, or another object detection process, can be performed on the detection device using the extracted image features. The object recognition process can attempt to determine a presence of objects represented in the image data, such as those that match object patterns or have feature vectors that correspond to various defined object types, among other such options. In at least some embodiments each potential object determination will come with a corresponding confidence value, for example, and objects with at least a minimum confidence value that corresponding to specified types of objects may be selected as objects of interest. If it is determined that no objects of interest are represented in the frame of image data, then new image data may be captured.

If, however, one or more objects of interest are detected in the image data, the objects can be analyzed to determine relevant information. In the example process the objects will be analyzed individually for purposes of explanation, but it should be understood that object data can be analyzed concurrently as well in at least some embodiments. An object of interest can be selected and at least one descriptor for that object can be determined. The types of descriptor in some embodiments can depend at least in part upon the type of object. For example, a human object might have descriptors relating to height, clothing color, gender, or other aspects discussed elsewhere herein. A vehicle, however, might have descriptors such as vehicle type and color, etc. The descriptors can vary in detail, but should be sufficiently specific such that two objects in similar locations in the area can be differentiated based at least in part upon those descriptors. Content for display can then be determined based on the at least one descriptor, and the content can then be displayed.

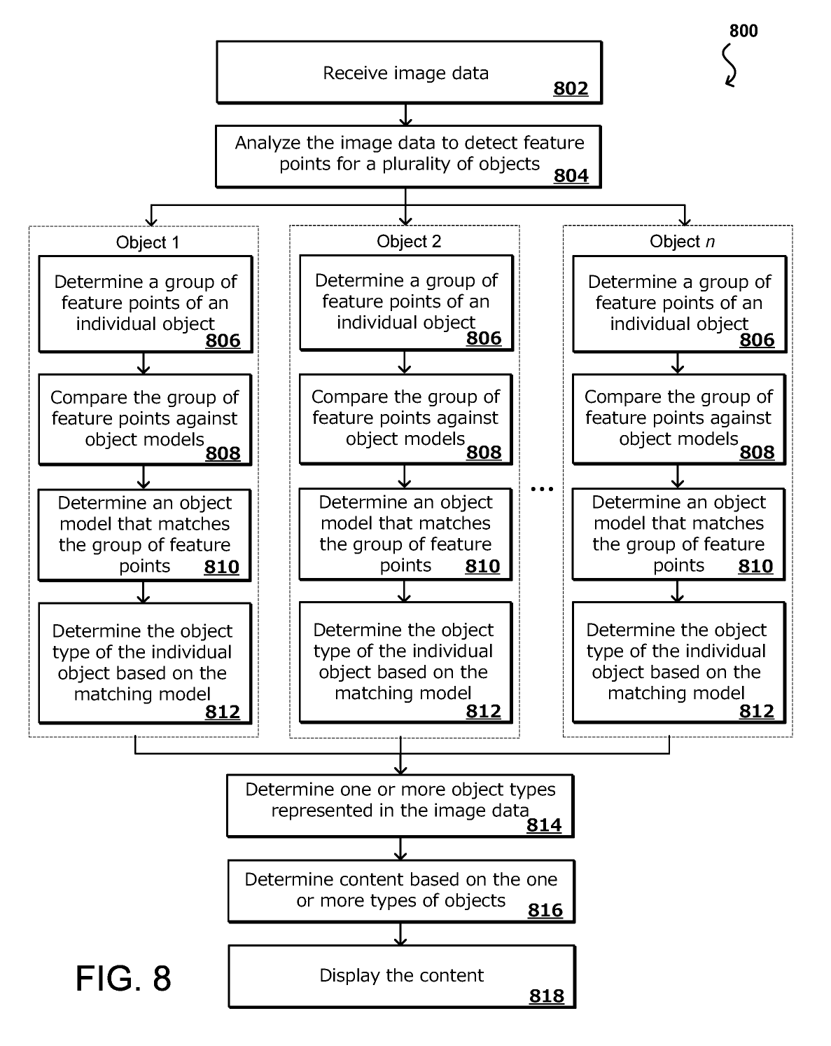

FIG. 8 illustrates an example process 800 for determining content based on multiple detected objects, in accordance with example embodiments. In this example, image data is received 802, and the image data is analyzed 804 to detect feature points for a plurality of objects. In various embodiments, for the individual objects of the plurality of objects, a group of feature points of the individual object is determined 806. The group of feature points is compared 808 against one or more object models, similar to the object models described above, which represent certain object types. Thus, an object model that matches the group of feature points is determined 810 and the object type of the individual object is determined 812 based on the matching model and the object type associated with the matching model. For example, in various embodiments, the object type may be detected using various machine learning based models, such as artificial neural networks, trained to classify detected objects (e.g., group of feature points) as belonging to one or more object types. In various embodiments in which the object is detected to be a person, the group of feature points representing the object (a subset thereof) may also be analyzed using real-time inference techniques to determine an emotional state of the person, which may be used to data collection or content selection. Steps 806 through 812 may be performed for any or all of the plurality of objects detected at step 804. Accordingly, one or more object types of the plurality of objects are determined 814. For example, it may be the case that the objects are determined to belong to the same object type, or different object types. Content may be determined 816 based on the one or more object types of the plurality of object types. The content may then be displayed 818. In an example embodiment, a number of each different object type is determined and the content may be selected based on the object type having the most number of objects.

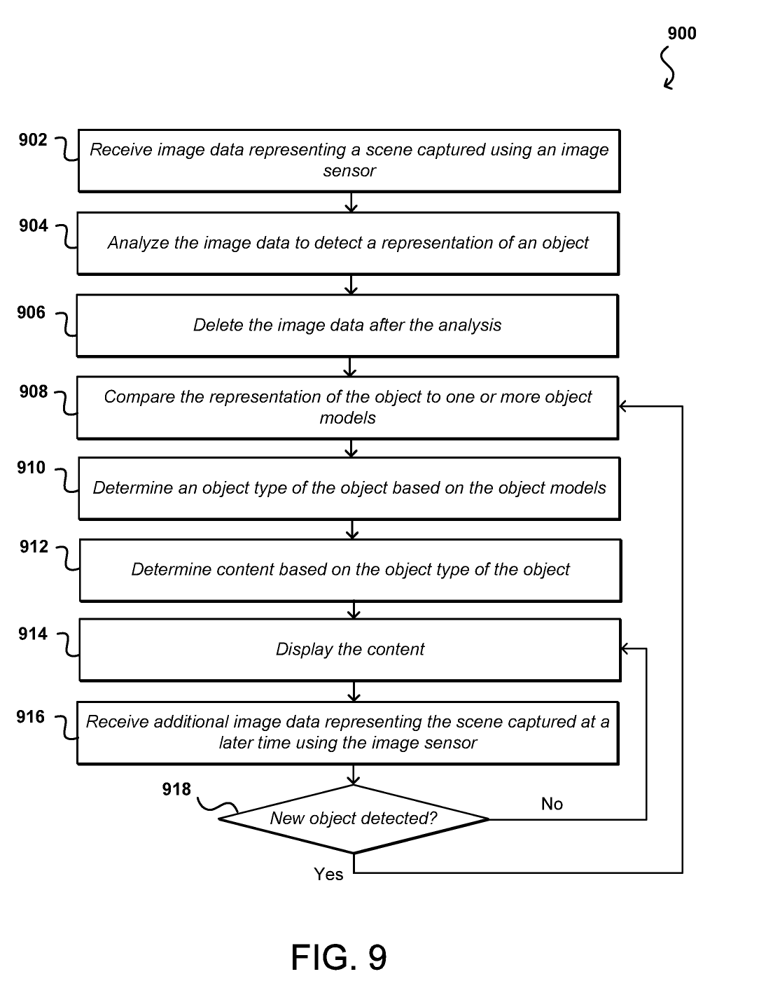

FIG. 9 illustrates an example process 900 of updating content of a display, in accordance with example embodiments. In this example, image data is received 902, the image data representing a scene captured using an image sensor of a content display device or system. The image data is analyzed 904 to detect a representation of an object within the scene. The image data can be deleted 906 after the analysis. The representation of the object can be compared 908 to one or more object models to determine 910 an object type of the object based on the object models. Specifically, it may be determined which of the object models the representation of the object most closely remembered based on extract feature points, pixels, or other image processing and object recognition techniques. Content can then be determined 912 based on the determined object type. The content is then displayed 914 on the display of the content display device or system. Additional image data may be received 916, the additional image data representing the scene captured at a later time using the image sensor. It is then determined 918 whether a new object is detected as being represented in the image data. If no new object is detected, the previously displayed content may continue to be displayed. Alternatively, if a new object is detected, a representation of the new object is compared 908 to the object models to determine 910 an object type for the new object. Content is then determined 912 based on the object type of the new object and displayed 914 on the display of the content display device or system. In some embodiments, the new object may be determined to be of the same object type as the previously detected object and the content remains the same. Alternatively, the new object may be determined to be a different object type and different content is displayed.

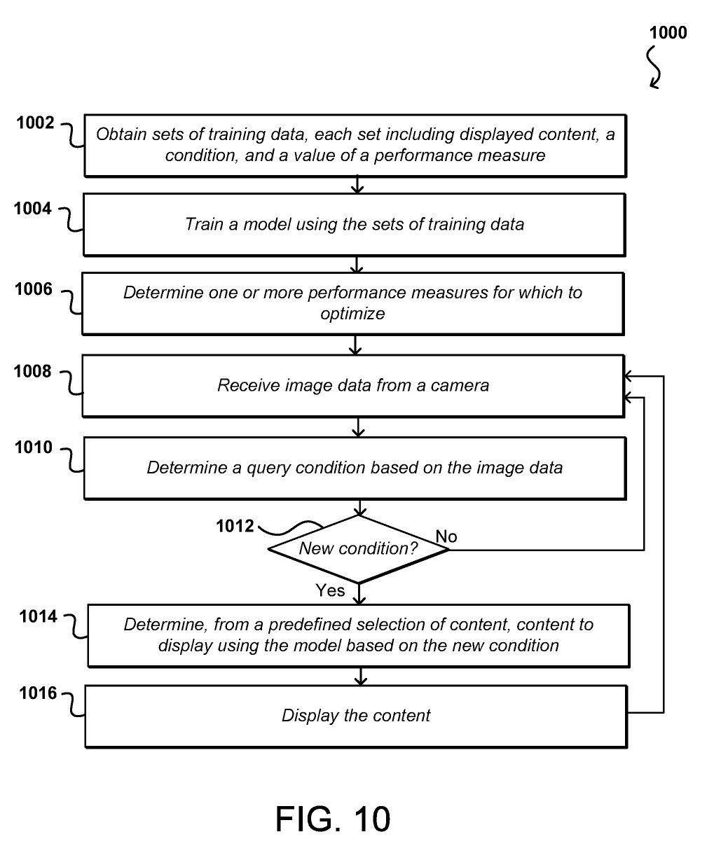

FIG. 10 illustrates a process 1000 for optimizing display content under various conditions, in accordance with various embodiments of the present disclosure. In this example, sets of training data (e.g., data points) are obtained 1002, in which each set of training data includes i) a display content, ii) a condition, and iii) a value of a performance measure. A model can be trained 1004 can be trained using the obtained sets of training data. In some embodiments, the model may include a plurality of sub-models, such as a sub-model for each performance measure. In various embodiments, to use to the model to determine content, one or more performance measure for which to optimize are determined 1006. For example, the performance measure may be determined based on an input from a user. Once the model is trained, it can be used to determine display content. Specifically, image data can be received 1008 from a camera having a field of view, and a condition associated with the field of view can be determined 1010 from the image data. It can then be determined 1012 whether the condition is a new condition. If a new condition is present, display content can be determined 1014 using the model and based on the new condition, and the content can be displayed 1016. In various embodiments, the condition may include various types of visual or image based scenarios. For example, the condition may be weather, such as whether it's sunny, cloud, rainy, etc. The condition may also refer to type of objects represented in the image data, such as described above. The condition may also include a number of objects represented in the image data. The condition may also include a measure of traffic flow, among many others.

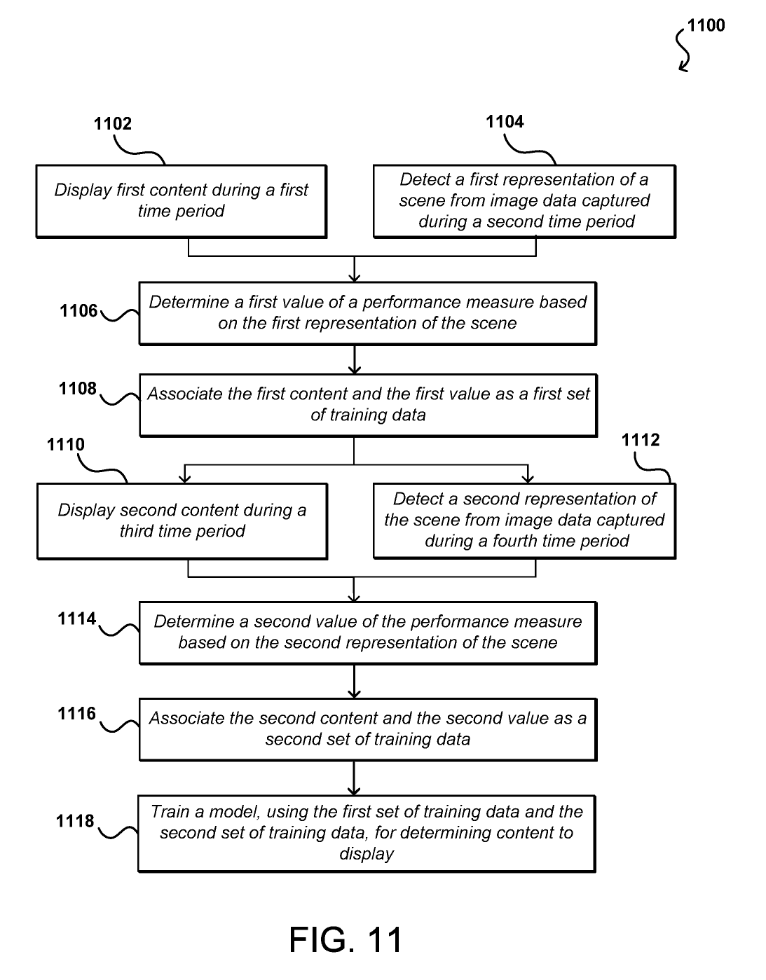

FIG. 11 illustrates an example process 1100 of training a content selection model, accordance with example embodiments. In this example, training data is obtained and used to train a model for determining display content for a display system. Specifically, first content is displayed 1102 during a first time period and image data is captured by a camera during a second time period, from which a first representation of a scene is detected 1104. The second time period is associated with the first time period in that the second period follows the first time period within a defined period of time, or overlaps with the first period in a defined manner, or occurs at the same time as the first period. A first value of a performance measure is determined 1106 based on the first representation of the scene. For example, the performance measure may be the number of people detected in the representation of the scene. In other embodiments, the first value may be determined based on data collected from another source, such as number of sales made during the first period of time. The first content and the first value are associated 1108 with each other to form a first set of training data (i.e., first data point). In order to obtain additional training data, second content is displayed 1110 during a third time period and image data is captured by a camera during a fourth time period, from which a second representation of the scene is detected 1112. A second value of a performance measure is determined 1114 based on the second representation. The second content and the second value are associated 1116 with each other to form a second set of training data (i.e., second data point). A plurality of additional sets of training data can be obtained in a similar manner. Thus, a model can be trained 1118 using the sets of training data. Once trained, the model can be used to determine the best content to display, such as to optimize for the performance measure.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A display system, comprising:
a camera;
a display;
a processor; and
memory including instructions that, when executed by the processor, cause the device to:
capture image data of a scene using the camera;
analyze the image data to detect a plurality of feature points indicative of one or more objects;
delete the image data after completion of the analysis;
determine a number of objects from the plurality of feature points;
for individual objects of the one or more objects:
determine a group of feature points from the plurality of feature points indicative of an individual object;
compare the group of feature points against at least one object model corresponding to a type of object; and
determine the type of object of the individual object based on the group of feature points matching the at least one object model;
determine one or more types of objects indicated by the plurality of feature points;
determine content based at least on the one or more types of objects; and
cause the display to display the content.

2. The display system of claim 1, wherein the memory further includes instructions that, when executed by the processor, cause the device to:
determine a number of objects belonging to at least one of the one or more object types; and
determine the content based at least on the number of objects belonging to the at least one of the one or more object types.

3. The display system of claim 2, wherein the memory further includes instructions that, when executed by the processor, cause the device to:
determine a first number of objects belonging to a first object type;
determine a second number of objects belonging to a second object type; and
determine the content based at least on the first number and the second number.

4. The display system of claim 1, wherein the memory further includes instructions that, when executed by the processor, cause the device to:
determine a first object type and a second object type indicated by the plurality of feature points; and
determine the content based at least on the combination of the first object type and the second object type.

5. The display system of claim 1, wherein the memory further includes instructions that, when executed by the processor, cause the device to:
determine a position of the individual object based on a position of the group of feature points within the plurality of feature points.

6. The display system of claim 5, wherein the memory further includes instructions that, when executed by the processor, cause the device to:
determine a position of another individual object based on a position of another group of feature points; and
determine the content based on the positions of the two individual objects.

7. The display system of claim 1, wherein the memory further includes instructions that, when executed by the processor, cause the device to:
determine values for at least one respective descriptor based at least in part upon pixels in the image data that correspond to the one or more objects, a type of the at least one respective descriptor depending at least in part on the one or more types of objects.

8. The display system of claim 1, wherein the camera, processor, and memory are positioned in a device housing and located remote from the display, at least the processor being communicative with the display via a communications element.

9. A display device, comprising:
an image sensor directed at a field of view;
a display;
a processor; and
memory including instructions that, when executed by the processor, cause the device to:
generate image data representing a scene within the field of view using the image sensor;
analyze the image data locally in real-time to detect a representation of an object in the scene and determine an object type for the object based on the representation of the object and one or more object models;
delete at least a portion of the image data in real-time after completion of the analysis;
determine content to display based at least on the object type;
cause the display to display the content;
detect a representation of a new object in the scene and determine a new object type for the new object based on the representation of the new object and the one or more object models;
determine new content to display based at least on the new object type; and
cause the display to display the new content.

10. The display device of claim 9, wherein the memory further includes instructions that, when executed by the processor, cause the device to:
determine a set of feature points from the image data corresponding to the object; and
comparing the set of feature points against the one or more object models to determine the object type.

11. The display device of claim 9, wherein the memory further includes instructions that, when executed by the processor, cause the device to:
determine values for at least one object descriptor based at least in part upon pixels in the image data the correspond to the object, a type of the at least one object descriptor depending at least in part on the type of object.

12. The display device of claim 9, wherein the memory further includes instructions that, when executed by the processor, cause the device to:
determine a performance measure associated with the content and the object type, the performance measure indicating an effectiveness of the content with respect to the object type.

13. The display device of claim 9, wherein the memory further includes instructions that, when executed by the processor, cause the device to:
detect a representation of a plurality of objects in the scene;
determine one or more object types of the plurality of objects; and
determine the content based at least in part on the one or more object types of the plurality of objects.

14. The display device of claim 9, wherein the image data includes a sequence of frames, and wherein the memory includes instructions that, when executed by the processor, cause the device to:
analyze and subsequently delete a first set of frames of the sequence of frames; and
analyze and subsequently delete a second set of frames of the sequence of frames, the second set of frames and the first set of frame being adjacent in the sequence or separated by one or more other frames.

15. The display device of claim 9, further comprising:
a device housing, the display making up a front face of the device housing, the processor and the memory located within the device housing, and the image sensor positioned proximate the front face.

16. The display device of claim 15, wherein the image sensor is at least partially located within the device housing, a light-capturing component of the image sensor being exposed to the field of view.

17. A display System, comprising:
a display configured to display a content item during a first period of time; and
an object detection device, comprising:
an image sensor;
a processor; and
memory including instructions that, when executed by the processor, cause the object detection device to:
capture image data of a scene within a field of view of the image sensor during a second period of time associated with the first period of time;
analyze the image data to detect representations of distinct objects in the scene during the second period of time,
delete the image data after the analysis;
determine a number of distinct objects represented in the image data; and
associate the number with the second period of time.

18. The display device of claim 17, wherein the display is configured to display an additional content item during a third period of time, and wherein the instructions, when executed by the processor, further cause the object detection device to
capture additional image data of the scene during a fourth period of time associated with the third period of time;
analyze the additional image data to detect representations of distinct objects in the scene during the fourth period of time;
delete the additional image data after the analysis of the additional image data;
determine a number of distinct objects represented in the additional image data; and
associate the number of distinct objects represented in the additional image data with the additional content item.

19. The display device of claim 18, wherein the instructions, when executed by the processor, further cause the object detection device to:
determine a more effective content item of the two content items based at least in part on a comparison between the numbers of distinct objects associated with the two content items, respectively.

20. The display device of claim 17, wherein the instructions, when executed by the processor, further cause the object detection device to:
determine one or more object types of the distinct objects; and
determine a number of the distinct objects belonging to an object type of the one or more object types.
